(19) United States
(12) Patent Application Publication
(10) Pub. No.: US 2019/0055402 A1
(43) Pub. Date: Feb. 21, 2019

(54) POLYAMIDE RESIN COMPOSITION AND MOLDED ARTICLE FORMED THEREBY

(71) Applicant: ASAHI KASEI KABUSHIKI KAISHA, Tokyo (JP)

(72) Inventor: Shunichiro I, Tokyo (JP)

(73) Assignee: ASAHI KASEI KABUSHIKI KAISHA, Tokyo (JP)

(21) Appl. No.: 16/048,739

(22) Filed: Jul. 30, 2018

(30) Foreign Application Priority Data
Aug. 17, 2017 (JP) 2017-157378

(51) Int. Cl. C08L 77/06; C08L 53/00; C08L 53/02; C08L 23/08; C08K 3/04; C08K 3/34; C08K 3/40; C08K 7/10; C08K 7/14

(52) U.S. Cl. CPC C08L 77/06; C08L 53/005; C08L 53/02; C08L 23/0815; C08K 2201/003; C08K 3/34; C08K 3/40; C08K 7/10; C08K 7/14; C08K 3/04

(57) ABSTRACT

To provide a polyamide resin composition which exhibits superior impact resistance and in which fluctuations in physical properties, that is, variation in impact resistance, tensile strength, and tensile elongation are suppressed. The polyamide resin includes: (A) 65 to 90 parts by mass of a polyamide resin; (B) 10 to 35 parts by mass of an impact modifier; (C) 0.1 to 0.5 parts by mass of carbon black with respect to 100 parts by mass of the total amount of Component (A) and Component (B); and (D) 1 to 100 parts by mass of an inorganic filler with respect to 100 parts by mass of the total amount of Component (A) and Component (B, wherein the average primary particle diameter of Component (C) is 20 nm or less.

### TECHNICAL FIELD

The present disclosure is related to a polyamide resin composition containing an impact modifier and carbon black, which exhibits superior impact resistance and suppresses fluctuations in physical properties, and a molded article formed thereby.

### BACKGROUND ART

Polyamide resin is employed in various industrial fields by taking advantage of the characteristics thereof, which are favorable fluidity, high heat resistance, and mechanical properties. In recent years, so called polymer alloys, in which various rubbers are blended with polyamide and complexed so as to further improve properties with respect to impact that cannot be obtained by a single polyamide resin alone, have been proposed. Rubbers employed in such a polymer alloy include, for example, ethylene propylene rubber (EPR), ethylene butylene rubber (EBR), styrene ethylene/butylene styrene rubber (SEBS), etc. However, these so called non polar rubbers and polyamides are generally immiscible. For this reason, when blending with polyamide, a so called modified rubber, which is a rubber copolymerized with or addition reacted with a functional group capable of reacting with polyamide such as maleic anhydride, which is an α, β-unsaturated carboxylic acid, is utilized. Patent Documents 1 and 2 disclose technology relating to modified rubbers, as specific proposals for improving impact resistance.

Compared with unmodified rubber (block copolymer), the modified block copolymers disclosed in Patent Documents 1 and 2 have dramatically improved compatibility with polyamide, and these documents disclose that the impact resistance of polyamide compositions are greatly improved, for example.

### BACKGROUND ART DOCUMENTS

### Patent Documents

### [Patent Document 1]

Japanese Unexamined Patent Publication No. H2-88671

### [Patent Document 2]

Japanese Unexamined Patent Publication No. H1-304156

### SUMMARY

However, although the impact resistance is improved in the compositions disclosed in Patent Documents 1 and 2, fluctuations in the physical properties thereof tend to become great.

The present disclosure provides a polyamide resin composition which exhibits superior impact resistance and in which fluctuations in physical properties, that is, variation in impact resistance, tensile strength, and tensile elongation are suppressed. The present disclosure also provides a molded article formed by the polyamide resin composition.

As a result of intensive studies to solve the above problems, the present inventors have achieved the present disclosure.

That is, the polyamide resin composition of the present disclosure is a polyamide resin composition comprising:

(A) 65 to 90 parts by mass of a polyamide resin;

(B) 10 to 35 parts by mass of an impact modifier;

(C) 0.1 to 0.5 parts by mass of carbon black with respect to 100 parts by mass of the total amount of Component (A) and Component (B); and

(D) 1 to 100 parts by mass of an inorganic filler with respect to 100 parts by mass of the total amount of Component (A) and Component (B);

the average primary particle diameter of Component (C) being 20 nm or less.

It is preferable for Component (B) to be at least one selected from a group consisting of: an ethylene-α-olefin copolymer consisting of ethylene and at least one α-olefin having 3 to 12 carbon atoms; a modified ethylene-α-olefin copolymer obtained by bonding the above ethylene-α-olefin copolymer with an α, β-unsaturated carboxylic acid or a derivative thereof; a hydrogenated block copolymer obtained by hydrogenating at least a portion of a block copolymer that includes at least one polymer block having a vinyl aromatic compound as a principal component and at least one polymer block having a conjugated diene compound as a principal component; and a modified hydrogenated block copolymer obtained by bonding the above hydrogenated block copolymer with an α, β-unsaturated carboxylic acid or a derivative thereof.

More preferably, the α, β-unsaturated carboxylic acid or the derivative thereof in Component (B) is maleic anhydride.

It is preferable for Component (A) to be polyamide 66, polyamide 6, a polyamide 66/6 copolymer, a polyamide 66/6I copolymer, polyamide 610, polyamide 612, or a mixture thereof.

It is preferable for Component (D) to be at least one selected from a group consisting of glass fibers, glass flakes, talc, wollastonite, kaolin, and mica.

The molded article of the present disclosure is formed by molding the polyamide resin composition of the present disclosure.

According to the present disclosure, it is possible to provide a polyamide resin composition that suppresses deterioration in impact resistance and suppresses fluctuations in impact resistance, tensile strength, and tensile elongation. It is also possible to provide a molded article formed by the polyamide resin.

### DETAILED DESCRIPTION OF THE EMBODIMENTS

The present disclosure will be described in detail below.

### [(A): Polyamide Resin]

In the present disclosure, examples of the polyamide resin include an aliphatic polyamide resin such as polyamide 46, polyamide 6, polyamide 66, polyamide 610, polyamide 612, polyamide 11, polyamide 12, for example; an aromatic polyamide resin such as hexamethylene terephthalamide, hexamethylene isophthalamide, and metaxylylene adipamide that contain an aromatic component such as a terephthalic acid, isophthalic acid and metaxylylene diamine, for example; as well as copolymerized polyamides and mixed polyamides containing the foregoing as a principal constituent component. Among these, preferred polyamides are polyamide 66, polyamide 6, a polyamide 66/6 copolymer, a polyamide 66/6I copolymer (hexamethylene adipamide-hexamethylene isophthalamide), polyamide 610, polyamide 612, or mixtures thereof.

It is preferable to use a polyamide of which the thermal stability is improved by adding a copper compound that contains copper acetate and copper iodide (together with potassium iodide in some cases) as components to the polyamide. The thermal stabilization process may be carried out at any step during the production of the polyamide. For example, the copper compound that contains copper acetate and copper iodide as constituent components may be added to a monomer, and thereafter polymerization may be carried out thereafter. Alternatively, the copper compound that contains copper acetate and copper iodide as constituent components may be added during processing by an extruder or a molding device while the polyamide is in a molten state, after the polymer is obtained by polymerization. As a further alternative, the copper compound that contains copper acetate and copper iodide as components may be directly mixed with polymer pellets and then subjected to a molding process.

The molecular weight of the polyamide which is employed in the present disclosure is not particularly limited, but is preferably within a range from 1.5 to 3.5 in terms of the sulfuric acid relative viscosity ηr (according to JIS K6920). The molecular weight of the polyamide is more preferably within a range from 1.8 to 3.0, and even more preferably within a range from 2.0 to 2.9, from the viewpoint of achieving a favorable balance between fluidity and mechanical properties.

It is preferable for the terminal group amounts of the polyamide resin (A) which is employed in the present disclosure to be within a range from 10 to 100 milliequivalents for amino groups and a range from 40 to 150 milliequivalents for carboxyl groups, per kilogram of polyamide. It is more preferable for the terminal group amounts of the polyamide resin (A) to be within a range from 20 to 90 milliequivalents for amino groups and a range from 50 to 120 milliequivalents for carboxyl groups, from the viewpoint that reactions with the α, β-unsaturated carboxylic acid or a derivative thereof will be favorable when the impact modifier (B) to be described later is a modified ethylene-α copolymer.

The amount of Component (A) is within a range from 65 to 90 parts by mass, preferably a range from 70 to 88 parts by mass, and more preferably a range from 75 to 85 parts by mass, from the viewpoint of mechanical properties.

### [(B): Impact Modifier]

The impact modifier of the present disclosure is not particularly limited as long as it is a compound that improves impact resistance. However, it is preferable for the impact modifier to be at least one selected from a group consisting of: an ethylene-α-olefin copolymer having ethylene and at least one α-olefin having 3 to 12 carbon atoms; a modified ethylene-α-olefin copolymer obtained by bonding the above ethylene-α-olefin copolymer with an α, β-unsaturated carboxylic acid or a derivative thereof, a hydrogenated block copolymer obtained by hydrogenating at least a portion of a block copolymer that includes at least one polymer block having a vinyl aromatic compound as a principal component and at least one polymer block having a conjugated diene compound as a principal component; and a modified hydrogenated block copolymer obtained by bonding the above hydrogenated block copolymer with an α, β-unsaturated carboxylic acid or a derivative thereof.

### (Ethylene-α-Olefin Copolymer)

The ethylene-α-olefin copolymer is constituted by ethylene and at least one α-olefin having 3 to 12 carbon atoms. Examples of α-olefins having 3 to 12 carbon atoms include propylene, butene-1, pentene-1, hexene-1,4-methylpentene-1, heptene-1, octene-1, nonene-1, decene-1, undecene-1, dodecene-1, etc. An α-olefin having 4 to 10 carbon atoms is more preferable from the viewpoint of improving impact resistance.

It is preferable for the ethylene-α-olefin copolymer to have a density within a range from 0.855 to 0.885 g/cm³. An ethylene-α-olefin copolymer having a density within this range has superior flexibility and a low modulus at low temperatures. If such an ethylene-α-olefin copolymer is modified with a specific functional group, even more superior impact resistance can be obtained. Moreover, note that the density is a value measured according to ASTM D-792.

The melt flow rate of the ethylene-α-olefin copolymer which is employed in the present disclosure is not particularly limited, but it is preferable for the melt flow rate to be within a range from 0.01 to 300 g/10 min (at 190° C. with a 2.16 kg load). It is more preferable for the melt flow rate to be within a range of 0.05 to 100 g/10 min from the viewpoint of achieving a favorable balance between fluidity and impact resistance. Moreover, note that the melt flow rate is a value measured in accordance with ASTM D-1238.

The ethylene-α-olefin copolymer may be produced by employing a Ziegler type catalyst and a metallocene type catalyst. The metallocene type catalyst is constituted by a cyclopentadienyl derivative of a Group IV metal such as titanium and zirconium, and a cocatalyst. Not only is the metallocene catalyst highly active as a polymerization catalyst, the molecular weight distribution of an obtained polymer is narrower, the distribution of α-olefin having 3 to 12 carbon atoms, which is a comonomer of the copolymer, is more uniform, and the catalyst species is more uniform, compared to a conventional catalyst, for example, a Ziegler type catalyst. Therefore, it is preferable for the metallocene type catalyst to be employed. By employing this catalyst, the composition ratio of the comonomer can be increased compared to conventional techniques, resulting in a low modulus, elastomeric polymer having superior flexibility being obtained.

### (Modified Ethylene-α-Olefin Copolymer)

The modified ethylene-α-olefin copolymer is that in which an α, β-unsaturated carboxylic acid or a derivative thereof is bonded to the ethylene-α-olefin copolymer. Examples of the α, β-unsaturated carboxylic acid or derivative thereof which is employed to prepare the modified ethylene-α-olefin copolymer include: maleic acid, maleic anhydride, fumaric acid, itaconic acid, acrylic acid, methacrylic acid, succinic acid, succinic anhydride, crotonic acid, phthalic acid, phthalic anhydride, etc. Among these, maleic anhydride is particularly preferred.

The modified ethylene-α-olefin copolymer may be obtained, for example, by adding the α, β-unsaturated carboxylic acid or a derivative thereof to the ethylene-α-olefin copolymer in a solution state or in a molten state, with or without utilizing a radical initiator.

### (Hydrogenated Block Copolymer)

The hydrogenated block copolymer is that in which at least a portion of a block copolymer that includes at least one polymer block having a vinyl aromatic compound as a principal component and at least one polymer block having a conjugated diene compound as a principal component is hydrogenated. The hydrogenated block copolymer is obtained by selectively hydrogenating a conjugated diene portion of a block copolymer comprising a vinyl aromatic compound polymer block and a conjugated diene compound polymer block.

The term “principal” in the polymer block that includes the vinyl aromatic compound as a principal component of the present disclosure means that at least 50% by mass of the block is an aromatic vinyl compound. It is more preferable for at least 70% by mass, even more preferable for at least 80% by mass, and most preferable for at least 90% by mass of the block to be an aromatic vinyl compound. The same applies to the term “principal” in the polymer block that includes the conjugated diene compound as a principal component, and this term means that at least 50% by mass of the block is a conjugated diene compound. It is more preferable for at least 70% by mass, even more preferable for at least 80% by mass, and most preferable for at least 90% by mass of the block to be a conjugated diene compound.

In this case, for example, even in the case of a block in which a small amount of a conjugated diene compound or another compound is randomly bonded in the vinyl aromatic compound block, if 50% by mass of the block is formed from a vinyl aromatic compound, the block will be regarded as a block copolymer having a vinyl aromatic compound as a principal component. Further, this also applies to the case of the conjugated diene compound.

Representative examples of vinyl aromatic compounds which may be employed include styrene, α-methylstyrene, vinyl xylene, ethyl vinyl xylene, vinyl naphthalene, and mixtures thereof. Examples of the conjugated diene compound include butadiene, isoprene, 1,3-pentadiene or 2,3-dimethyl butadiene, and mixtures thereof. It is preferable for the vinyl aromatic compound to be styrene and for the conjugated diene compound to be butadiene.

The two end blocks of these block copolymers may be the same or different. The number average molecular weight of these block copolymers is not particularly limited, but is preferably within a range from 10,000 to 800,000, and more preferably a range from 20,000 to 500,000. Moreover, note that the number average molecular weight is a value measured by gel permeation chromatography (GPC mobile phase: chloroform, reference material: polystyrene).

The content of the vinyl aromatic compound in the block copolymer is not particularly limited, but is preferably within a range from 10 to 70% by mass, and more preferably a range from 10 to 55% by mass.

The hydrogenated block copolymer which is utilized in the present disclosure is obtained by selectively hydrogenating the conjugated diene portion of the block copolymer. For example, the bock copolymer may be hydrogenated in an n-hexane and cyclohexane mixed solvent with cobalt naphthenate and triethyl aluminum as catalyst. Thereby, the hydrogenated block copolymer, in which a portion not exceeding 20% of the aromatic double bond of the vinyl aromatic compound block is hydrogenated and a at least 80% of the aliphatic double bond of the conjugated diene compound polymer block is hydrogenated, may be synthesized.

### (Modified Hydrogenated Block Copolymer)

Further, a modified hydrogenated block copolymer, which is obtained by adding an α, β-unsaturated carboxylic acid or a derivative thereof to the above hydrogenated block copolymer, may be employed from the viewpoint of improving impact resistance by reacting with polyamide. Examples of the α, β-unsaturated carboxylic acid or a derivative thereof include: maleic acid, maleic anhydride, fumaric acid, itaconic acid, acrylic acid, methacrylic acid, succinic acid, succinic anhydride, crotonic acid, phthalic acid, phthalic anhydride acid, etc. Among these, maleic anhydride is preferred. The modified hydrogenated block copolymer is obtained by adding an α, β-unsaturated carboxylic acid or a derivative thereof to a hydrogenated block copolymer in a solution state or a molten state, with or without utilizing a radical initiator.

The bonded amount of the α, β-unsaturated carboxylic acid or a derivative thereof (hereinafter also referred to as “modification amount”) in the modified hydrogenated block copolymer or the modified ethylene-α-olefin copolymer is not particularly limited, but it is preferable for the bonded amount to be within a range from 0.1 to 3% by mass and more preferably a range from 0.15 to 1.8% by mass with respect to the unmodified hydrogenated block copolymer or the ethylene-α-olefin copolymer. When the modification amount is 0.1% by mass or greater, the advantageous effects of a modified block copolymer can be sufficiently obtained. Not only can sufficient impact resistance be obtained when the block copolymer or the ethylene-α-olefin copolymer is formed into a composition, but there is also a tendency for phase crack phenomenon to not be observed in molded articles. In addition, if the modification amount is 3% by mass or less, there is a tendency for deterioration of heat resistance and significant deterioration of molding processing properties to be prevented.

The content of Component (B) is 10 to 35 parts by mass, preferably 12 to 30 parts by mass, and more preferably 15 to 25 parts by mass from the viewpoints of impact resistance and heat resistance.

### [(C): Carbon Black]

Commonly used furnace type carbon black, channel type carbon black, lamp type carbon black, etc. may be used as the carbon black which is employed in the present disclosure. The average primary particle diameter is 20 nm or less from the viewpoints of fluctuations in impact resistance, tensile strength, and tensile elongation. Within this range, Component (C) appropriately suppresses the rubber efficiency of Component (B). The present inventors speculate that therefore, it is possible to reduce fluctuations in impact resistance, tensile strength and tensile elongation, and to suppress reduction in impact resistance (however, the advantageous effects are not limited to these). As a method of adding carbon black, a master batch may be prepared by melt kneading the carbon black with a polyamide resin in advance, and then this master batch may be added to Components (A), (B), and (D).

Moreover, note that the average primary particle diameter is obtained by acquiring an aggregate enlarged image by the procedure described in ASTM D 3849 (standard test method of carbon black—morphological characterization by electron microscopy), measuring the particle diameters of 3000 particles as unit constituent particles within the aggregate enlarged image, and then calculating an average value of the measured values.

From the viewpoints of suppressing fluctuations in impact resistance, tensile strength, and tensile elongation, the content of Component (C) is preferably 0.1 to 0.5 parts by mass, preferably 0.15 to 0.5 parts by mass, and more preferably 0.15 to 0.4 parts by mass, with respect to 100 parts by mass of the total of the Components (A) and (B).

### [(D): Inorganic Filler]

The shape of the inorganic filler to be employed in the present disclosure is not particularly limited, and known inorganic fillers may be utilized. An inorganic filler selected from a group consisting of glass fibers, glass flakes, talc, wollastonite, kaolin, and mica may be utilized. In addition, it is also preferable for a surface treatment to be administered according to the material of Component (D) is to be used. Examples of such surface treatments include those that administer treatment using various coupling agents such as silane series coupling agents and titanate series coupling agents, as well as treatment using a sizing agent such as an epoxy type resin, a urethane type resin, etc.

The content of Component (D) is within a range from 1 to 100 parts by mass and preferably a range from 10 to 75 parts by mass with respect to 100 parts by mass of the total of Components (A) and (B), from the viewpoint of mechanical strength.

### [Other Ingredients]

Moreover, various additives may be blended into the polyamide resin composition of the present disclosure within a range that will not impair the objective of the present disclosure. Examples of such additives include heat stabilizers for polyamide such as phosphorous compounds, oxidative deterioration preventing agents such as hindered phenol and hindered amine, light stabilizers such as manganese compounds, HALS (hindered amine), nucleating agents such as talc and boron nitride, inorganic fillers such as calcium carbonate, coloring agents such as titanium oxide, nigrosine, and phthalocyanine type dyes, plasticizers, charge retention inhibitors, and other thermoplastic resins. In the case that such components are added, it is preferable for the total content of such components to be within a range from 0.01 to 5 parts by mass, and more preferably a range from 0.1 to 3 parts by mass with respect to 100 parts by mass of the total of Components (A) and (B).

### [Method for Producing Polyamide Resin Composition]

The polyamide resin composition of the present disclosure is obtained by melt kneading polyamide and other raw materials. For example, after blending all of the raw materials with a device such as a tumbler in advance using a twin screw extruder, the blended raw materials may be supplied from a feed port (top feed) positioned at the most upstream side. Alternatively, a predetermined amount of a portion of the raw materials may be supplied from a feed port provided at the downstream side. In order to perform melt kneading of the raw material which is supplied to the extruder, a combination of elements such as a feed screw element and a kneading screw element (kneading disc) may be utilized. The composition which is melt kneaded in this manner is molded into strand shapes by spinning apertures which are provided at the leading end of the extruder at the downstream side, and then the composition is obtained by cooling and cutting.

The polyamide resin composition of the present disclosure may be employed in molding processes such as injection molding, extrusion molding, blow molding, press molding, etc.

### EXAMPLES

Hereinafter, the present disclosure will be described in detail with specific examples and comparative examples.

### (Method for Evaluating Raw Material Properties)

The physical properties which will be described in the following Examples and Comparative Examples were evaluated as follows.

<Sulfuric Acid Relative Viscosity ηr>

The polyamide resins of Component (A) were dissolved in 98% sulfuric acid and measured in accordance with JIS K 6920.

### (Preparation of Each Component)

### [Component (A): Polyamide Resin]

(a-1): Polyamide 612 ηr 2.3
(a-2): Polyamide 66 ηr 2.8

### [Component (B): Impact Modifier]

(b-1): ethylene-octene copolymer (EOR), octene content 28% by mass, density 0.86, melt flow rate (MFR)=0.5
(b-2): maleic anhydride modified ethylene-octene copolymer (m-EOR)
(b-1) above was modified with maleic anhydride (MAH) and was utilized as (b-2). Moreover, note that the modification method was that in which the unmodified ethylene-α-olefin copolymer, peroxide (Perhexa 25B) and MAH were mixed and degassed with a vacuum pump to remove unreacted maleic acid using a twin-screw extruder while melt kneading to form pellets. After pulverizing the obtained pellets, unreacted maleic anhydride was extracted with acetone, and then maleic anhydride which was graft reacted by infrared absorption spectrum of a pressed film was quantified.
m-EOR: modified amount 0.7% by mass, octene content 28% by mass
(b-3): hydrogenated maleic anhydride-modified styrene-butadiene copolymer, approximately 20% by mass of styrene component, modified amount 1.2% by mass

### [Component (C): Carbon Black]

(c-1): carbon black average primary particle diameter 13 nm
(c-2): carbon black Mitsubishi (registered trademark) carbon black #52B (by Mitsubishi Chemical Corporation), average primary particle diameter 27 nm

### [Component (D): Inorganic Filler]

(d-1): glass fibers treated with a sizing agent containing aminosilane⋅urethane acid copolymer with number average fiber diameter 10 μm

### Examples 1 Through 6, Comparative Examples 1 Through 5

A twin screw extruder (ZSK-26MC by Coperion (Germany)) having an upstream side supply port in the first barrel from the upstream side of the extruder and a downstream side supply port in the ninth barrel with an L/D (extruder cylinder length/extruder cylinder diameter) of 48 (number of barrels: 12) was employed. In this twin screw extruder, the temperature from the upstream side supply port to the die was set to 260° C., the screw rotation speed was set to 300 rpm, (degree of pressure reduction −0.08 MPa) and the discharge rate was set to 25 kg/hour. Under these conditions, Components (A) through (C) were supplied from the upstream side feed port and Component (D) was supplied from the downstream side feed port so that the proportions described in the upper portion of Table 1 below were obtained. Then, these components were melt kneaded to produce pellets of the polyamide resin composition.

### <Charpy Impact Strength>

An injection molding machine (product name “PS40E”, by Nissei Plastic Co., Ltd.) was employed to obtain 4 mm thick ISO test pieces from the polyamide resin composition pellets by injection molding. The injection molding conditions were: a cylinder temperature of 290° C., a mold temperature of 80° C., an injection time of 25 seconds, and a cooling time of 15 seconds. Measurements of Charpy impact strength were conducted according to ISO 179 using the obtained ISO test pieces. 10 samples were measured for each polyamide resin composition, and standard deviations were calculated as indices of fluctuation.

### <Tensile Test>

An injection molding machine (product name “PS40E”, by Nissei Plastic Co., Ltd.) was employed to obtain 4 mm thick ISO test pieces from the polyamide resin composition pellets by injection molding. The injection molding conditions were: a cylinder temperature of 270° C., a mold temperature of 80° C., an injection time of 25 seconds, and a cooling time of 15 seconds. Measurements of tensile strength and tensile elongation were conducted according to ISO 527-1 using the obtained ISO test pieces. 10 samples were measured for each polyamide resin composition, and standard deviations were calculated as indices of fluctuation.

TABLE 1

| | | Example 1 | Example 2 | Example 3 | Example 4 | Example 5 | Example 6 |
|---|---|---|---|---|---|---|---|
| (A) Polyamide | Type | a-1 | a-1 | a-1 | a-1 | a-1 | a-2 |
| Resin | Parts by Mass | 75 | 80 | 75 | 75 | 75 | 80 |
| (B) Impact | Type | b-1 | b-1 | b-1 | b-1 | b-1 | b-3 |
| Modifier | Parts by Mass | 12.5 | 10 | 12.5 | 12.5 | 12.5 | 20 |
| | Type | b-2 | b-2 | b-2 | b-2 | b-2 | |
| | Parts by Mass | 12.5 | 10 | 12.5 | 12.5 | 12.5 | |
| (C)Carbon | Type | c-1 | c-1 | c-1 | c-1 | c-1 | c-1 |
| Black | Parts by Mass | 0.18 | 0.18 | 0.1 | 0.4 | 0.5 | 0.18 |
| (D) Inorganic | Type | d-1 | d-1 | d-1 | d-1 | d-1 | d-1 |
| Filler | Parts by Mass | 50 | 50 | 50 | 50 | 50 | 50 |
| Evaluations | Charpy(kJ/m²) | 36 | 33 | 36 | 36 | 35 | 28 |
| | Charpy Std. Dev. | 0.43 | 0.47 | 0.51 | 0.47 | 0.51 | 0.39 |
| | Tensile Strength Std. Dev. | 0.10 | 0.14 | 0.18 | 0.16 | 0.30 | 0.15 |
| | Tensile Elongation Std. Dev. | 0.08 | 0.06 | 0.10 | 0.12 | 0.15 | 0.10 |

| | | Comparative | Comparative | Comparative | Comparative | Comparative |
|---|---|---|---|---|---|---|
| | | Example 1 | Example 2 | Example 3 | Example 4 | Example 5 |
| (A) Polyamide | Type | a-1 | a-1 | a-1 | a-1 | a-2 |
| Resin | Parts by Mass | 75 | 75 | 75 | 75 | 80 |
| (B) Impact | Type | b-1 | b-1 | b-1 | b-1 | b-3 |
| Modifier | Parts by Mass | 12.5 | 12.5 | 12.5 | 12.5 | 20 |
| | Type | b-2 | b-2 | b-2 | b-2 | |
| | Parts by Mass | 12.5 | 12.5 | 12.5 | 12.5 | |
| (C)Carbon | Type | | c-1 | c-1 | c-2 | c-1 |
| Black | Parts by Mass | | 0.05 | 0.9 | 0.18 | 0.9 |
| (D) Inorganic | Type | d-1 | d-1 | d-1 | d-1 | d-1 |
| Filler | Parts by Mass | 50 | 50 | 50 | 50 | 50 |
| Evaluations | Charpy(kJ/m²) | 37 | 37 | 34 | 33 | 26 |
| | Charpy Std. Dev. | 1.27 | 1.09 | 0.61 | 0.83 | 0.65 |
| | Tensile Strength Std. Dev. | 0.42 | 0.40 | 0.66 | 0.41 | 0.61 |
| | Tensile Elongation Std. Dev. | 0.12 | 0.13 | 0.19 | 0.11 | 0.17 |

### INDUSTRIAL APPLICABILITY

The polyamide resin composition of the present disclosure has a high Charpy impact strength, and little fluctuations in physical properties. Therefore, the polyamide resin composition of the present disclosure will be effective for utilization as an industrial material for various industrial machine parts, electric/electronic parts, etc.

What is claimed is:

1. A polyamide resin composition, comprising:
(A) 65 to 90 parts by mass of a polyamide resin;
(B) 10 to 35 parts by mass of an impact modifier;
(C) 0.1 to 0.5 parts by mass of carbon black with respect to 100 parts by mass of the total amount of the Component (A) and the Component (B); and
(D) 1 to 100 parts by mass of an inorganic filler with respect to 100 parts by mass of the total amount of the Component (A) and the Component (B);
the average primary particle diameter of the Component (C) being 20 nm or less.

2. A polyamide resin composition as defined in claim 1, wherein:
the Component (B) is at least one selected from a group consisting of: an ethylene-α-olefin copolymer consisting of ethylene and at least one α-olefin having 3 to 12 carbon atoms; a modified ethylene-α-olefin copolymer obtained by bonding the ethylene-α-olefin copolymer with an α, β-unsaturated carboxylic acid or a derivative thereof; a hydrogenated block copolymer obtained by hydrogenating at least a portion of a block copolymer that includes at least one polymer block having a vinyl aromatic compound as a principal component and at least one polymer block having a conjugated diene compound as a principal component; and a modified hydrogenated block copolymer obtained by bonding the hydrogenated block copolymer with an α, β-unsaturated carboxylic acid or a derivative thereof.

3. A polyamide resin composition as defined in claim 2, wherein:
the α, β-unsaturated carboxylic acid or the derivative thereof in the Component (B) is maleic anhydride.

4. A polyamide resin composition as defined in claim 1, wherein:
the Component (A) is polyamide 66, polyamide 6, a polyamide 66/6 copolymer, a polyamide 66/6I copolymer, polyamide 610, polyamide 612, or a mixture thereof.

5. A polyamide resin composition as defined in claim 2, wherein:
the Component (A) is polyamide 66, polyamide 6, a polyamide 66/6 copolymer, a polyamide 66/6I copolymer, polyamide 610, polyamide 612, or a mixture thereof.

6. A polyamide resin composition as defined in claim 3, wherein:
the Component (A) is polyamide 66, polyamide 6, a polyamide 66/6 copolymer, a polyamide 66/6I copolymer, polyamide 610, polyamide 612, or a mixture thereof.

7. A polyamide resin composition as defined in claim 1, wherein:
the Component (D) is at least one selected from a group consisting of glass fibers, glass flakes, talc, wollastonite, kaolin, and mica.

8. A polyamide resin composition as defined in claim 2, wherein:
the Component (D) is at least one selected from a group consisting of glass fibers, glass flakes, talc, wollastonite, kaolin, and mica.

9. A polyamide resin composition as defined in claim 3, wherein:
the Component (D) is at least one selected from a group consisting of glass fibers, glass flakes, talc, wollastonite, kaolin, and mica.

10. A polyamide resin composition as defined in claim 4, wherein:
the Component (D) is at least one selected from a group consisting of glass fibers, glass flakes, talc, wollastonite, kaolin, and mica.

11. A molded article formed by molding a polyamide resin composition as defined in claim 1.
